(19) United States
(12) Patent Application Publication
(10) Pub. No.: US 2026/0147848 A1
(43) Pub. Date: May 28, 2026

(54) CUSTOM DIGITAL CONTENT GENERATION USING ON-DEVICE CONTEXTUAL DATA

(71) Applicant: Adobe Inc., San Jose, CA (US)

(72) Inventors: Viswanathan SWAMINATHAN, Saratoga, CA (US); Saayan MITRA, San Jose, CA (US); Gavin Stuart Peter MILLER, Los Altos, CA (US); Eunyee KOH, Sunnyvale, CA (US); Deepak PAI, Sunnyvale, CA (US)

(21) Appl. No.: 18/957,518

(22) Filed: Nov. 22, 2024

(51) Int. Cl. G06F 16/957

(52) U.S. Cl. CPC G06F 16/9577

(57) ABSTRACT

Some aspects relate to technologies for generating custom digital content using a content intent descriptor from a content server and on-device contextual data maintained on a user device. In some aspects, a user device receives a content intent descriptor communicated over a network from a content server. The user device generates a prompt using the content intent descriptor and on-device contextual data maintained on the user device. A generative model is caused to generate a digital content item using the prompt, and the digital content item is presented on the user device.

### BACKGROUND

Personalization of digital content on the Internet involves tailoring digital experiences to individual users based on things like their preferences, behaviors, and interactions. This process often leverages contextual data regarding a user such as user demographics, browsing history, search queries, and social media activity to deliver relevant digital content including advertisements, recommendations, and other information. Personalization enhances user engagement by making digital content delivered to user devices more relevant. However, it can also raise concerns about privacy and data security, as it often relies on collecting and analyzing personal information.

### SUMMARY

Some aspects of the present technology relate to, among other things, generating custom digital content using a content intent descriptor from a content server and on-device contextual data maintained on a user device. In some configurations, the custom digital content is generated on the user device. In accordance with such configurations, the user device receives a content intent descriptor from the content server and uses on-device contextual data to generate a prompt. This prompt is then fed into an on-device generative model, which creates a digital content item tailored based on the content intent descriptor and the on-device contextual data. The generated digital content item is presented on the user device.

In other configurations, the custom digital content is generated on the content server. In accordance with such configurations, the user device receives a content intent descriptor from the content server and uses on-device contextual data to generate a prompt. However, instead of generating a digital content item on the user device, the prompt is sent back to the content server. The content server provides the prompt as input to a generative model to produce a digital content item, which is then transmitted from the content server to the user device for presentation.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a sequence diagram illustrating a sequence of actions performed by a content server and a user device to generate custom digital content on the user device using on-device contextual data and a content intent descriptor in accordance with some implementations of the present disclosure;

FIG. 3 is a flow diagram showing a method performed by a user device to generate a digital content item on the user device using on-device contextual data and a content intent descriptor in accordance with some implementations of the present disclosure;

FIG. 4 is a block diagram illustrating another exemplary system in accordance with some implementations of the present disclosure;

FIG. 5 is a sequence diagram illustrating a sequence of actions performed by a content server and a user device to generate custom digital content on the content server using on-device contextual data and a content intent descriptor in accordance with some implementations of the present disclosure;

FIG. 6 is a flow diagram showing a method performed by a user device for server-side content generation using on-device contextual data and a content intent descriptor in accordance with some implementations of the present disclosure;

FIG. 7 is a flow diagram showing a method performed by a content server for server-side content generation using on-device contextual data and a content intent descriptor in accordance with some implementations of the present disclosure; and

FIG. 8 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, the term “digital content item” refers to digital media that can be presented by user devices and, in some cases, communicated over a network, such as the Internet. A digital content item can include one or more modalities, such as text, image, audio, and video. A digital content item can be any of a variety of different types. By way of example, in some aspects, a digital content item comprises marketing content (also referred to as a marketing message), intended to promote a product or service or to otherwise cause a potential customer to perform some action. In other aspects, a digital content item comprises other types of content, such as recommendations, news, push notifications, or other information.

The term “on-device contextual data” is used herein to refer to information or metadata about an end user, such as an end user's characteristics, environment, behaviors, or circumstances that is maintained on the end user's user device, such as a mobile device, tablet, or laptop computer. On-device contextual data can include, for instance: user demographics (e.g., age, gender, etc.); user geolocation (e.g., through IP address or GPS data); user device information (e.g., device type, operating system, browser, etc.); user behavior data regarding actions such as page views, clicks, time spent on a website, or previous engagement with specific digital content items. On-device contextual data can include information explicitly provided by an end user and/or information identified or otherwise determined by the end user's user device, for instance, based on user actions on the user device. In some aspects, the on-device contextual data can include any information on the user device, such as information from calendar entries, emails, and text messages.

The term “content intent descriptor” is used herein to refer to a data object that encapsulates information about the intended purpose and objectives of digital content to be generated and presented on a user device. A content intent descriptor can comprise data in different formats, such as text, images, audio, and/or video. By way of example only and not limitation, in the context of generating a marketing message, a content intent descriptor can comprise information regarding one or more products/services to be advertised. For instance, a content intent descriptor could include information based on a creative brief or a campaign brief that provides details for the creation of marketing content, which could include information regarding an objective, target audience, key message, tone, style, and type of digital content item to generate. In other instances, a content intent descriptor can specify information used to generate other forms of digital content items, such as recommendations, news, push notifications, or other information. Content intent descriptors can be defined by different entities, allowing each entity to have one or more descriptors tailored to their specific needs. For example, different advertisers can create unique content intent descriptors for their products, ensuring that the generated content aligns with their distinct marketing strategies and objectives.

As used herein, the term “prompt” refers to input to a generative model that guides or otherwise instructs the generative model to generate a digital content item. In accordance with aspects of the technology described herein, a prompt is generated based on a combination of a content intent descriptor and on-device contextual data. A prompt can comprise any combination of text, images, audio, video, or other input format.

A “generative model” is a type of machine learning model that learns to generate output digital content from a given training dataset. Unlike discriminative models, which focus on predicting a label or class for input data, generative models aim to understand the underlying distribution of the data in order to generate output digital content. Generative models can generate output digital content by sampling from this learned distribution, in order to perform tasks like image generation and text synthesis. Examples of generative models include Variational Autoencoders (VAEs) and Generative Adversarial Networks (GANs). In some aspects, a generative model can comprise a large language model (LLM). In some aspects, the generative model can be a multi-modal model that operates on inputs and/or generates outputs of different modalities, such as text, image, audio, and video.

### Overview

Given the vast number of user devices and the incredible amount of digital content distributed on the Internet, the generation and delivery of digital content items to user devices that is personalized for the recipients poses a technical challenge for content servers. For instance, in the current digital marketing era, enterprises face the challenge of creating digital content items in various forms, such as display ads. The need for a plethora of new, unique, and appealing digital content items that are personalized to recipients presents a significant challenge.

Providing custom digital content and experiences for users typically requires access to the users'personal data, potentially presenting privacy concerns. While some users may be comfortable sharing personal data, others are not. When the personal data available for a given user is limited, the user experience suffers.

Aspects of the technology described herein address these technical challenges by employing on-device contextual data with content intent descriptors from a content server to generate custom digital content. The on-device contextual data generally includes information about an end user's characteristics, environment, behaviors, or circumstances. The on-device contextual data is maintained on the user device of the end user, thereby addressing any privacy concerns. A content intent descriptor is a data object encapsulating information about the intended purpose and objectives of digital content to be generated. By combining on-device contextual data with content intent descriptors on a user device, custom digital content is generated in a way that secures the end user's contextual data.

Some configurations described herein involve generating digital content items directly on a user device. The user device stores on-device contextual data and includes a prompt component and a generative model. When the user device receives a content intent descriptor from a content server, the prompt component on the user device uses the content intent descriptor and the on-device contextual data to generate a prompt. This prompt is then provided to the generative model on the user device to generate a digital content item. The generated digital content item is then presented on the user device.

Other configurations described herein involve generating digital content items on a content server. Similar to the first configurations, the user device stores on-device contextual data and includes a prompt component. When the user device receives a content intent descriptor from a content server, the prompt component on the user device uses the content intent descriptor and the on-device contextual data to generate a prompt. The prompt is sent to the content server, which uses a generative model to create a digital content item. The generated digital content item is then transmitted from the content server to the user device for presentation.

Aspects of the technology described herein provide a number of improvements over existing technologies. For instance, the technology described herein enables the creation of personalized digital content items without transmitting personal data over a network or otherwise storing personal data on a server. Instead, personal data for an end user is maintained as on-device contextual data on the end user's user device. As such, this approach leverages on-device contextual data to enhance personalization while maintaining user privacy, as the contextual data remains on the user device (e.g., the contextual data never leaves the user device). In configurations in which the digital content item is generated on the content server, the prompt is generated to exclude any contextual data such that when the prompt is communicated to the content server, no contextual data leaves the user device. Furthermore, the server-content generation approach allows for the use of more powerful server-side processing capabilities while still utilizing the end user's contextual data to personalize the content and still ensuring the contextual data is not communicated from the user device.

### User Device Custom Content Generation Using On-Device Contextual Data

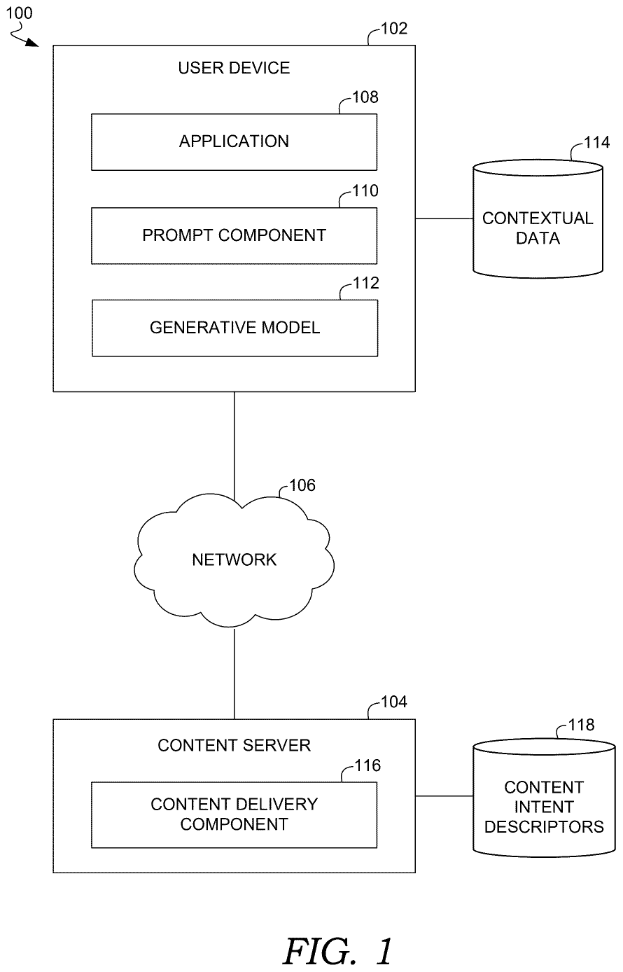

With reference now to the drawings, FIG. 1 is a block diagram illustrating an exemplary system 100 for generating custom digital content items on a user device using a content intent descriptor and on-device contextual data in accordance with some implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

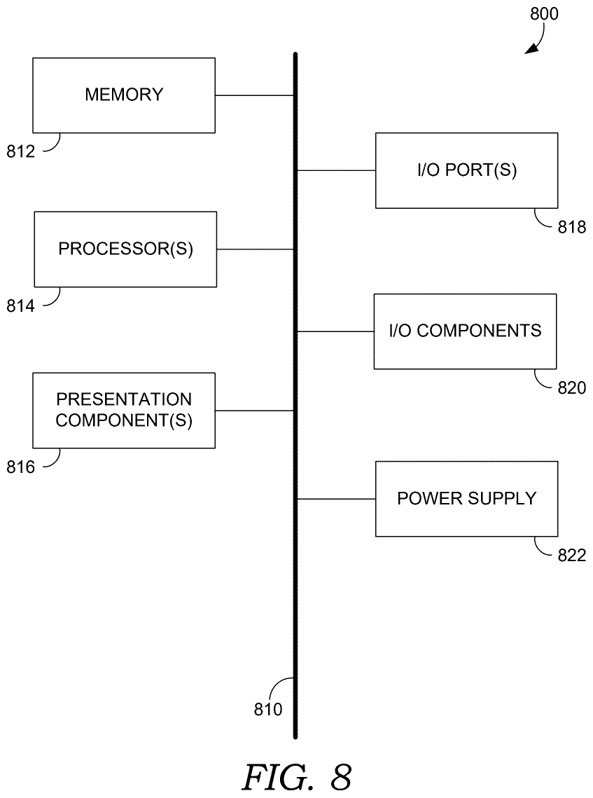

The system 100 is an example of a suitable architecture for implementing certain aspects of the present disclosure. Among other components not shown, the system 100 includes a user device 102 and a content server 104. Each of the user device 102 and the content server 104 shown in FIG. 1 can comprise one or more computer devices, such as the computing device 800 of FIG. 8, discussed below. As shown in FIG. 1, the user device 102 and the content server 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the content server 104 could be provided by multiple server devices collectively providing the functionality of the content server 104 as described herein. Additionally, other components not shown may also be included within the network environment.

The user device 102 can be a client device on the client-side of operating environment 100, while the content server 104 can be on the server-side of operating environment 100. The content server 104 can comprise server-side software designed to work in conjunction with client-side software on the user device 102 so as to implement any combination of the features and functionalities discussed in the present disclosure. For instance, the user device 102 can include an application 108 for interacting with the content server 104 and presenting digital content items on the user device 102. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the content server 104 remain as separate entities. While the operating environment 100 illustrates a configuration in a networked environment with a separate user device and content server, it should be understood that other configurations can be employed in which aspects of the various components are combined. For instance, in some aspects, aspects of the content server 104 can be implemented at least in part by the user device 102 and vice versa.

The user device 102 can comprise any type of computing device capable of use by a user. For example, in one aspect, the user device 102 can be the type of computing device 800 described in relation to FIG. 8 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the user device 102.

The content server 104 can be implemented using one or more server devices, one or more platforms with corresponding application programming interfaces, cloud infrastructure, and the like. While the content server 104 is shown separate from the user device 102 in the configuration of FIG. 1, it should be understood that in other configurations, at least some of the functions of the content server 104 can be provided on the user device 102 and vice versa.

As shown in FIG. 1, the user device 102 includes a prompt component 110 and a generative model 112; and the content server 104 includes a content delivery component 116. The components of the system 100 may be in addition to other components that provide further additional functions beyond the features described herein. In some aspects, the functions performed by components of the system 100 are associated with one or more applications, services, or routines. In particular, such applications, services, or routines may operate on one or more user devices, servers, may be distributed across one or more user devices and servers, or be implemented in the cloud. Moreover, in some aspects, these components of the system 100 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The content server 104 is a computer system designed to store, manage, and deliver digital content over the network 106 to user devices, such as the user device 102. Among other things, the content server 104 maintains a repository of one or more content intent descriptors, shown in FIG. 1 as the content intent descriptors data store 118. Each content intent descriptor is a data object that encapsulates information about the intended purpose and objectives of digital content to be generated and presented on a user device. A content intent descriptor can comprise data in different formats, such as text, images, audio, and/or video. By way of example only and not limitation, in the context of generating a marketing message, a content intent descriptor can comprise information regarding one or more products/services to be advertised. For instance, a content intent descriptor could include information based on a creative brief or a campaign brief that provides details for the creation of marketing content, which could include information regarding an objective, target audience, key message, tone, style, and type of digital content item to generate. In other instances, a content intent descriptor can specify information used to generate other forms of digital content items, such as recommendations, news, push notifications, or other information. Content intent descriptors can be defined by different entities, allowing each entity to have one or more descriptors tailored to their specific needs. For example, different advertisers can create unique content intent descriptors for their products, ensuring that the generated content aligns with their distinct marketing strategies and objectives.

The content server 104 includes a content delivery component 116, which transmits content intent descriptors over the network 106 to user devices, such as the user device 102. The content delivery component 116 can provide content intent descriptors to user devices in a variety of different scenarios in which digital content is to be presented by the user devices. These include situations in which user devices request content from the content server 104 and situations in which the content server 104 pushes content to user devices. By way of example and not limitation, this could include scenarios involving the presentation of advertisements and other marketing messages, recommendations, news feeds, push notifications, and other content on the user devices.

The user device 102 stores on-device contextual data in a contextual data store 114 maintained on the user device 102. The on-device contextual data includes information or metadata about an end user of the user device 102, such as the end user's characteristics, environment, behaviors, or circumstances. The on-device contextual data can include, for instance: user demographics (e.g., age, gender, etc.); user geolocation (e.g., through IP address or GPS data); user device information (e.g., device type, operating system, browser, etc.); user behavior data regarding actions such as page views, clicks, time spent on a website, or previous engagement with specific digital content items. The on-device contextual data can include information explicitly provided by the end user of the user device 102 and/or information identified or otherwise determined by the user device 102, for instance, based on user actions on the user device 102. In some aspects, the on-device contextual data can include any information on the user device, such as information from calendar entries, emails, and text messages.

In some aspects, the on-device contextual data is securely maintained on the user device 102 using one or more data security strategies. For instance, the on-device contextual data can be encrypted, ensuring that data is converted into a secure format that can only be accessed by authorized entities. This can be achieved, for instance, through full-disk encryption or file-level encryption. Access control mechanisms can also be employed that limit access to the on-device contextual data to specific applications via authentication. For instance, access to the on-device contextual data could be authorized for just the prompt component 110 such that other applications and components on the user device cannot access the data.

In the configuration of FIG. 1, when the user device 102 receives a content intent descriptor from the content server 104, the user device 102 uses the content intent descriptor and on-device contextual data to generate a digital content item that is presented by the application 108 on the user device. More particularly, the user device 102 includes a prompt component 110 that provides a prompt for input to a generative model 112 to generate a digital content item. The prompt can be any input that guides the generative model 112 in creating a digital content item and can include various input formats such as text, images, audio, video, or a combination thereof. The prompt component 110 generates the prompt using a content intent descriptor received from the content server 104 and on-device contextual data from the contextual data store 114. By leveraging both the content intent descriptor and on-device contextual data, the prompt component 110 can generate highly personalized and relevant prompts that guide the generative model to create digital content items tailored to the end user's preferences and context.

The prompt component 110 uses a content intent descriptor and on-device contextual data in various ways to provide a prompt to the generative model 112. By way of example only and not limitation, in some aspects, the prompt component 110 simply provides the content intent descriptor and on-device contextual data as input to the generative model (i.e., the prompt is the content intent descriptor and on-device contextual data). In some aspects, the prompt component 110 provides a prompt (which could be pre-defined text) that instructs the generative model 112 to generate a digital content item using a combination of the content intent descriptor and on device contextual data. In some aspects, the prompt component 110 generates the prompt by selecting specific types of on-device contextual data that are relevant to the content intent descriptor. For instance, if the content intent descriptor specifies generation of different content based on different age ranges, the prompt component 110 accesses age information for the end user from the on-device contextual data. In some aspects, the prompt component 110 uses on-device contextual data to select relevant information from the content intent descriptor for use in generating the prompt. For example, if the content intent descriptor includes information for multiple items (e.g., multiple products), the prompt component 110 could generate a prompt using information for one of those items that aligns best with the end user's recent behavior data, such as previous engagement with similar products.

By way of example to illustrate, suppose the user device 102 receives a content intent descriptor that includes details about a new smartphone launch, including key features for different audiences (e.g., certain features for tech-savvy individuals and other features for non-tech-savvy individuals) and desired tone (innovative and exciting). In this example, the on-device contextual data on the user device 102 includes information regarding the end user's recent searches for smartphones indicating an interest in high-end smartphones and geolocation indicating the end user is in a tech hub. Given this content intent descriptor and on-device contextual data, the prompt component 110 generates a prompt to highlight the smartphone's cutting-edge features, tailored to appeal to tech enthusiasts, with a focus on innovation and excitement.

As another example, suppose the user device 102 receives a content intent descriptor that includes information about various news categories (sports, technology, politics) and the objective to increase user engagement. Also suppose the on-device contextual data includes the user's browsing history showing a preference for technology news and geolocation data indicating they are in an area with a recent tech event. In this example, the prompt component 110 generates a prompt that includes information from the content intent descriptor regarding the latest technology news with instructions to emphasize the recent tech event in the end user's area.

After the prompt component 110 generates a prompt from the received content intent descriptor and on-device contextual data, the prompt is provided as input to the generative model 112 to generate a digital content item, which is presented by the application 108 on the user device 102. In some aspects, the generative model 112 comprises a language model that includes a set of statistical or probabilistic functions to perform Natural Language Processing (NLP) in order to understand, learn, and/or generate human natural language content. For example, a language model can be a tool that determines the probability of a given sequence of words occurring in a sentence or natural language sequence. Simply put, it can be a model that is trained to predict the next word in a sentence. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes—all with limited to no supervision. Accordingly, an LLM can comprise a deep neural network that is very large (e.g., billions to hundreds of billions of parameters) and understands, processes, and produces human natural language by being trained on massive amounts of text. These models can predict future words in a sentence letting them generate sentences similar to how humans talk and write or otherwise in a form dictated, for instance, by a prompt.

The generative model 112 can comprise a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some aspects, the generative model 112 is optimized to fit on-device to perform content generations on user devices, such as the user device 102. The optimization of the generative model 112 can use any of a number of different techniques, such as pruning, quantization, knowledge distillation, and low-rank adaptation (LoRA). Implementing these techniques can make the generative model 112 more efficient and suitable for deployment on devices with limited resources, such as smartphones.

The generative model 112 in some configurations comprises a multimodal model having one or more neural networks (i.e., artificial neural networks) that provide an encoder-decoder architecture with a joint latent space for different modalities. As such, the generative model 112 can take input in one or more different modalities (e.g., text, images, audio, video, etc.) and generate an output in one or more different modalities (e.g., text, images, audio, video, etc.). By way of example only and not limitation, the generative model 112 can employ one or more of the following: a variational autoencoder (VAE), a generative adversarial network (GAN), a transformer, a cross-modal attention network, and a latent diffusion model.

When configured as a multimodal model, the generative model 112 can include separate encoders that generate latent representations of different input modalities. Each encoder comprises a neural network architecture that extracts features representing the input modality in a compressed, meaningful way. By way of example only and not limitation, text encoders for text data could employ recurrent neural networks (RNNs) or transformer-based architectures. Image encoders for image data could employ, for instance, convolutional neural networks (CNNs) or vision transformers. Audio and/or video encoders for audio/video data could employ, for instance, combinations of RNNs and CNNs (including 3-dimensional CNNs) or transformer-based architectures. In some configurations, the generative model 112 includes separate encoders for content intent descriptors and on-device contextual data.

The joint latent space of the multimodal model captures the underlying semantics of different modalities, allowing the model to understand and relate the information across the modalities. In order to provide combined latent representations of different modalities in the joint latent space, the model can also include a merging component that merges latent representations of different inputs (e.g., via concatenations, summation, average, and/or other fusion techniques). The combined latent representations in the joint latent space capture shared representations of different data types, allowing for interactions and transformations between modalities.

As a multimodal model, the generative model 112 can also include one or more decoders to generate outputs. Each decoder comprises a neural network architecture specialized to produce a specific type of output given a latent representation in the joint latent space. By way of example only and not limitation, text decoders to generate text data could employ RNNs or transformer-based architectures. Image decoders for generating image data could employ, for instance, convolutional neural networks (CNNs) or vision transformers. Audio and/or video decoders for generating audio/video data could employ, for instance, combinations of RNNs and CNNs (including 3-dimensional CNNs) or transformer-based architectures.

In some configurations, the generative model 112 is a pre-trained model (e.g., GPT-4) that has not been fined-tuned. In other configurations, the generative model 112 is a model that is built and trained from scratch or a pre-trained model that has been fine-tuned. In such configurations, the generative model 112 can be trained or fine-tuned using training data. The training data comprise, for instance, training samples that each include a combination of a sample content intent descriptor and sample contextual data, as well as a ground truth digital content item. During training, weights associated with each neuron can be updated. Originally, the generative model 112 can comprise random weight values or pre-trained weight values that are adjusted during training. In one aspect, the generative model is trained using backpropagation. The backpropagation process comprises a forward pass, a loss function, a backward pass, and a weight update. The forward pass can include, for instance, providing training data (e.g., a sample content intent descriptor and sample contextual data) as input to the generative model 112, which generates an output based on that input. A loss can be determined based on the output and the ground truth digital content item from the training sample, and the weights updated based on the loss. This process is repeated using the training data. The goal is to update the weights of each neuron (or other model component) to cause the generative model 112 to produce relevant digital content items when given prompts based on content intent descriptors and contextual data. Once trained, the weight associated with a given neuron can remain fixed. The other data passing between neurons can change in response to a given input. Retraining the network with additional training data can update one or more weights in one or more neurons.

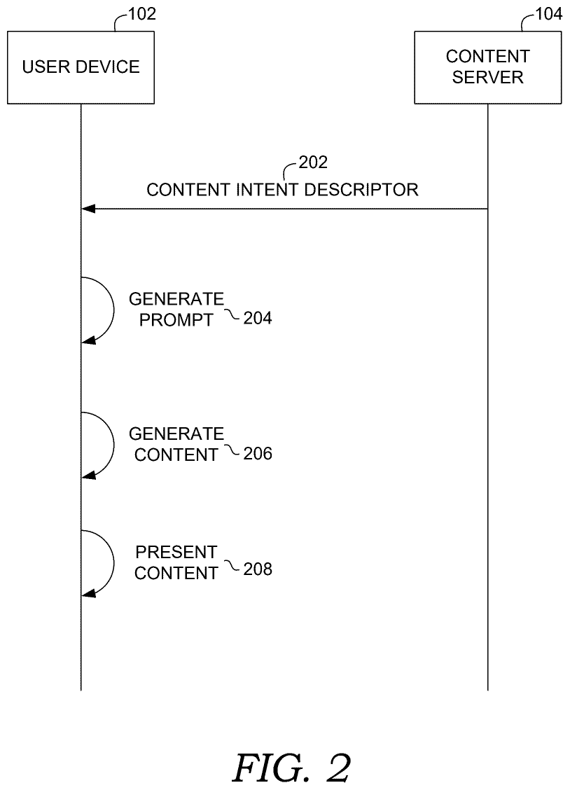

Turning next to FIG. 2, a sequence diagram is provided that shows a sequence of actions performed by the content server 104 and the user device 102 of FIG. 1 to generate custom digital content on the user device 102 using on-device contextual data and a content intent descriptor in accordance with some aspects of the technology described herein. At 202, the content server 104 provides a content intent descriptor over a network (e.g., the network 106) to the user device 102. At 204, the user device 102 accesses on-device contextual data (e.g., from the contextual data store 114) and generates (e.g., by the prompt component 110) a prompt using the content intent descriptor and the on-device contextual data. At 206, the user device 102 provides the prompt as input to an on-device generative model (e.g., the generative model 112), which outputs a digital content item based on the prompt. At 208, the user device 102 presents the digital content item (e.g., via the application 108).

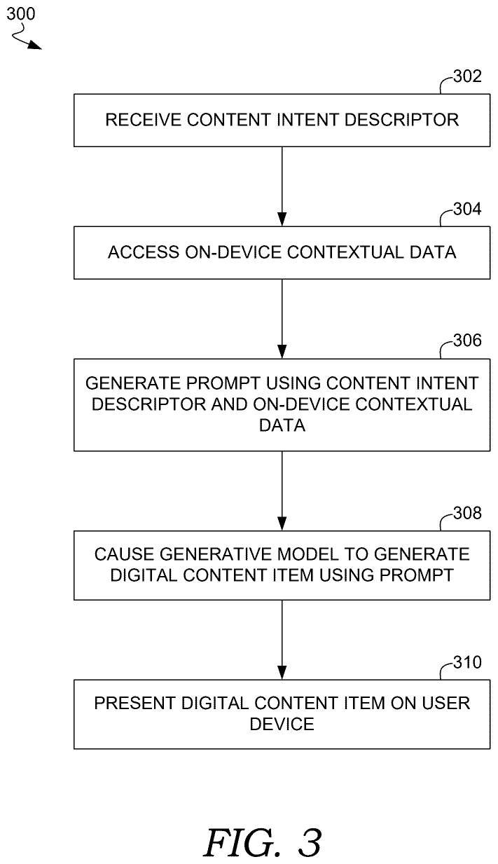

With reference now to FIG. 3, a flow diagram is provided that illustrates a method 300 performed by a user device to generate a digital content item on the user device using on-device contextual data and a content intent descriptor. The method 300 can be performed, for instance, by the user device 102 of FIG. 1. Each block of the method 300 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, a user device (e.g., the user device 102 of FIG. 1) receives a content intent descriptor communicated from a content server (e.g., the content server 104 of FIG. 1) over a network to the user device. The user device accesses on-device contextual data at block 304 and generates a prompt at block 306 using the content intent descriptor and the on-device contextual data. In some aspects, this could simply comprise providing the content intent descriptor and on-device contextual data as input. In other aspects, this could include processing the content intent descriptor and/or on-device contextual data to generate the prompt, such as selecting certain data from the content intent descriptor based on the on-device contextual data and vice versa.

The user device provides the prompt as input to a generative model on the user device, causing the generative model to generate a digital content item using the prompt, as shown at block 308. Depending on the use case, the digital content item can comprise one or more modalities (e.g., text, images, audio, video, etc.). The user device then presents the generated digital content item, as shown at block 310.

FIGS. 1-3 illustrate configurations in which digital content items are generated on a user device using a generative neural network model (e.g., the generative model 112). In further aspects of the technology described herein, a script could be used in place of a generative neural network model to generate digital content items on a user device. In other words, in the context of FIG. 1, the script replaces the generative model 112 on the user device 102. The script could reside on the user device 102 or be provided by the content server 104 or another server. The script comprises code that, when executed by a user device, combines a content intent descriptor and on-device contextual data to generate a digital content item. For example, the content intent descriptor could be a template, and the script could populate portions of the template with on-device contextual data, such as the user's name or profile picture. Using such a script would typically not generate digital content items that are as rich as those provided by a generative neural network model, but the script could be executed on lower end devices as it has lower power and memory requirements relative to a generative neural network model.

### Sever-Side Custom Content Generation Using On-Device Contextual Data

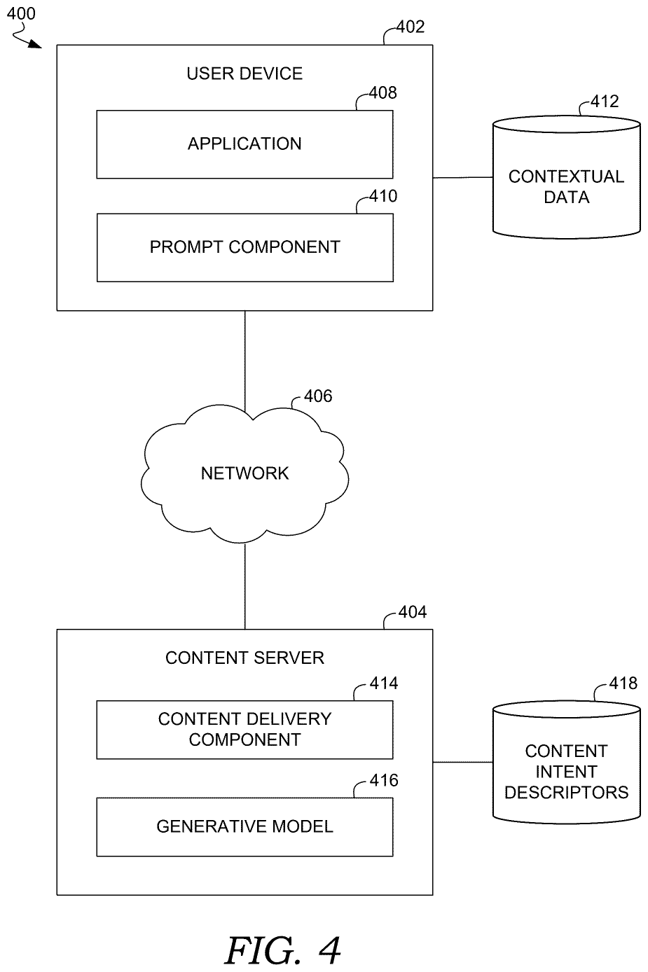

While FIGS. 1-3 illustrate a configuration in which custom digital content items are generated on user devices, FIGS. 4-7 illustrate a configuration in which custom digital content items are generated on a content server. With initial reference to FIG. 4, a block diagram is providing illustrating an exemplary system 400 for generating custom digital content items on a content server using content intent descriptors and on-device contextual data in accordance with some implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 400 is an example of a suitable architecture for implementing certain aspects of the present disclosure. Among other components not shown, the system 400 includes a user device 402, which can be similar to the user device 102 of FIG. 1, and a content server 404, which can be similar to the content server 104 of FIG. 1. Each of the user device 402 and the content server 404 shown in FIG. 4 can comprise one or more computer devices, such as the computing device 800 of FIG. 8, discussed below. As shown in FIG. 4, the user device 402 and the content server 404 can communicate via a network 406, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 400 within the scope of the present technology. Each may comprise a single device or multiple devices cooperating in a distributed environment. For instance, the content server 404 could be provided by multiple server devices collectively providing the functionality of the content server 404 as described herein. Additionally, other components not shown may also be included within the network environment.

The user device 402 can be a client device on the client-side of operating environment 400, while the content server 404 can be on the server-side of operating environment 400. The content server 404 can comprise server-side software designed to work in conjunction with client-side software on the user device 402 so as to implement any combination of the features and functionalities discussed in the present disclosure. For instance, the user device 402 can include an application 408 for interacting with the content server 404 and presenting digital content items on the user device 402. The application 408 can be, for instance, a web browser or a dedicated application for providing functions, such as those described herein. This division of operating environment 400 is provided to illustrate one example of a suitable environment, and there is no requirement for each implementation that any combination of the user device 402 and the content server 404 remain as separate entities. While the operating environment 400 illustrates a configuration in a networked environment with a separate user device and content server, it should be understood that other configurations can be employed in which aspects of the various components are combined. For instance, in some aspects, aspects of the content server 404 can be implemented at least in part by the user device 402 and vice versa.

The user device 402 can comprise any type of computing device capable of use by a user. For example, in one aspect, the user device 402 can be the type of computing device 800 described in relation to FIG. 8 herein. By way of example and not limitation, the user device 402 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the user device 402.

The content server 404 can be implemented using one or more server devices, one or more platforms with corresponding application programming interfaces, cloud infrastructure, and the like. While the content server 404 is shown separate from the user device 402 in the configuration of FIG. 4, it should be understood that in other configurations, at least some of the functions of the content server 404 can be provided on the user device 402 and vice versa.

As shown in FIG. 4, the user device 402 includes a prompt component 410; and the content server 404 includes a content delivery component 414 and a generative model 416. The components of the system 400 may be in addition to other components that provide further additional functions beyond the features described herein. In some aspects, the functions performed by components of the system 400 are associated with one or more applications, services, or routines. In particular, such applications, services, or routines may operate on one or more user devices, servers, may be distributed across one or more user devices and servers, or be implemented in the cloud. Moreover, in some aspects, these components of the system 400 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 400, it is contemplated that in some aspects, functionality of these components can be shared or distributed across other components.

Similar to the content server 104 of FIG. 1, the content server 404 is a computer system designed to store, manage, and deliver digital content over the network 406 to user devices, such as the user device 402. Among other things, the content server 404 maintains a repository of one or more content intent descriptors, shown in FIG. 4 as the content intent descriptors data store 418. The content delivery component 414 of the content server 404 is similar to the content delivery component 116 of FIG. 1 and transmits content intent descriptors over the network 406 to user devices, such as the user device 402. In the configuration of FIG. 4, a generative model 416 is provided on the content server 404. The generative model 416 can be similar to the generative model 112 of FIG. 1 (except for being located on the content server 404).

Similar to the user device 102 of FIG. 1, the user device 402 stores on-device contextual data in a contextual data store 412 maintained on the user device 402. The user device 402 also includes a prompt component 410 that can be similar to the prompt component 110 of FIG. 1. Given a content intent descriptor from the content server 404 and on-device contextual data from the contextual data store 412, the prompt component 410 generates a prompt, that is communicated from the user device 402 to the content server 404. In accordance with the configuration of FIG. 4, the prompt component 410 generates the prompt such that it does not include any of the on-device contextual data. This ensures that the on-device contextual data is maintained on the user device 402. For instance, suppose a content intent descriptor for generating a marketing message for a product includes information regarding a variety of product features. Given that content intent descriptor, the prompt component 410 could generate a prompt that includes certain features selected based on the on-device contextual data. In this way, the prompt only includes product information without any on-device contextual data.

When the content server 404 receives a prompt from the user device 402 (provided by the prompt component 410), the content server 404 provides the prompt to the generative model 416 on the content server, causing the generative model 416 to generate a digital content item (similar to the discussion above for the generative model 112 in FIG. 1). The content delivery component 414 then communicates the generated digital content item over the network 406 to the user device 402 for presentation on the user device 402 (e.g., via the application 408).

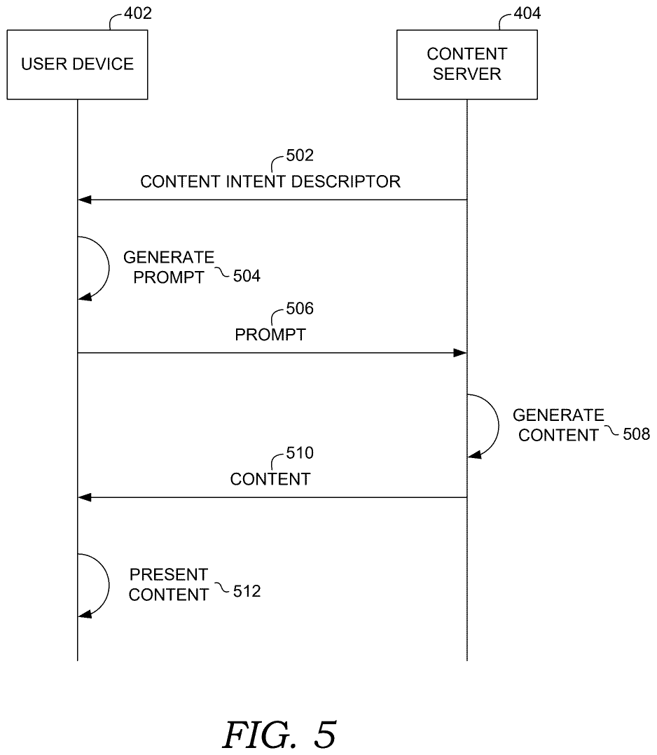

Turning next to FIG. 5, a sequence diagram is provided that shows a sequence of actions performed by the content server 404 and the user device 402 of FIG. 4 to generate custom digital content on the content server 404 using on-device contextual data and a content intent descriptor in accordance with some aspects of the technology described herein. At 502, the content server 404 provides a content intent descriptor over a network (e.g., the network 406) to the user device 402. At 504, the user device 402 accesses on-device contextual data (e.g., from the contextual data store 412) and generates (e.g., by the prompt component 410) a prompt using the content intent descriptor and the on-device contextual data. At 506, the user device 402 provides the prompt over the network to the content server 404. At 508, the content server 404 provides the prompt as input to a generative model (e.g., the generative model 416), which outputs a digital content item based on the prompt. At 510, the digital content item is communicated from the content server 404 over the network to the user device 402. At 512, the user device 402 presents the digital content item (e.g., via the application 408).

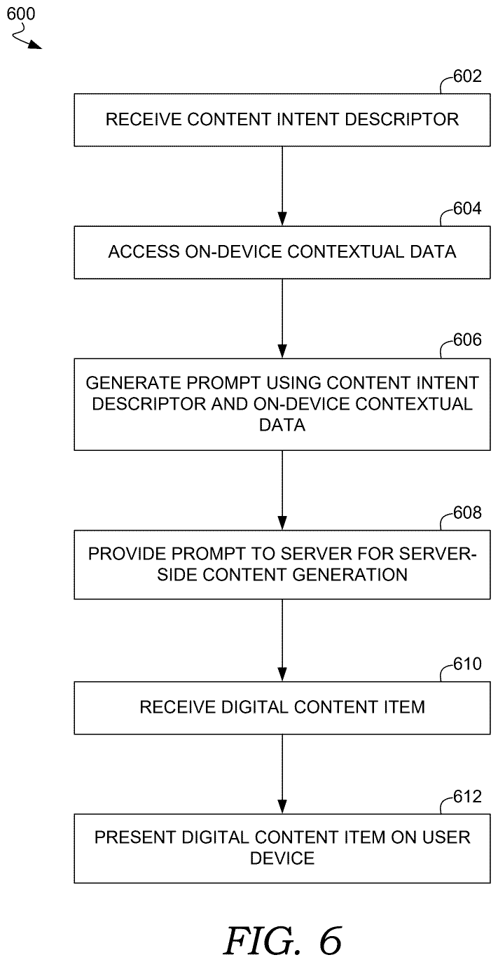

With reference now to FIG. 6, a flow diagram is provided that illustrates a method 600 performed by a user device for server-side content generation using on-device contextual data and a content intent descriptor. The method 600 can be performed, for instance, by the user device 402 of FIG. 4. As shown at block 602, a user device (e.g., the user device 402 of FIG. 4) receives a content intent descriptor communicated from a content server (e.g., the content server 404 of FIG. 4) over a network to the user device. The user device accesses on-device contextual data at block 604 and generates a prompt at block 606 using the content intent descriptor and the on-device contextual data. The prompt is generated such that it does not include any of the on-device contextual data in order to maintain the on-device contextual data on the user device.

The user device provides the prompt over the network to the content server, as shown at block 608. The content server provides the prompt as input to a generative model on the content server, causing the generative model to generate a digital content item using the prompt. Depending on the use case, the digital content item can comprise one or more modalities (e.g., text, images, audio, video, etc.). The user device receives the digital content item communicated over the network from the content server, as shown at block 610. The user device then presents the digital content item, as shown at block 612.

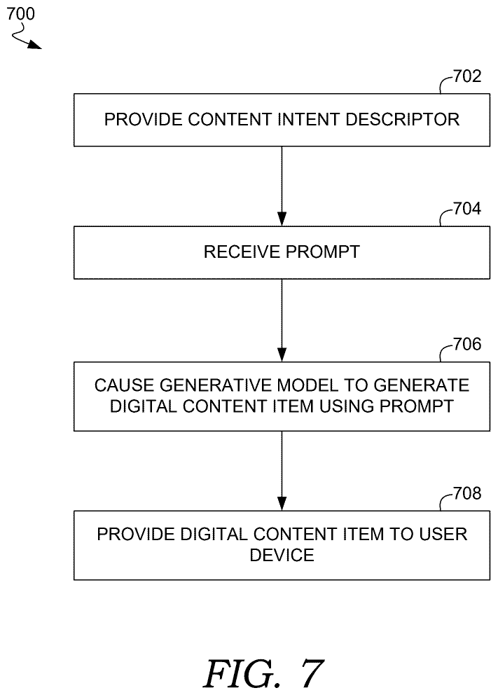

FIG. 7 provides a flow diagram that illustrates a method 700 performed by a content server for server-side content generation using on-device contextual data and a content intent descriptor. The method 700 can be performed, for instance, by the content server 404 of FIG. 4. As shown at block 702, a content server (e.g., the content server 404 of FIG. 4) communicates a content intent descriptor over a network to a user device (e.g., the user device 402 of FIG. 4). The user device generates a prompt using the content intent descriptor and on-device contextual data, and the content server receives the prompt over the network from the user device, as shown at block 704.

The content server provides the prompt as input to a generative model on the content server, causing the generative model to generate a digital content item using the prompt, as shown at block 706. Depending on the use case, the digital content item can comprise one or more modalities (e.g., text, images, audio, video, etc.). The server device communicates the digital content item over the network to the user, as shown at block 708, for presentation on the user device.

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving, at a user device, a content intent descriptor communicated over a network from a content server;
generating, on the user device, a prompt using the content intent descriptor and on-device contextual data maintained on the user device;
causing a generative model to generate a digital content item using the prompt; and
presenting the digital content item on the user device.

2. The one or more computer storage media of claim 1, wherein the prompt is generated on the user device by selecting information from the content intent descriptor based on the on-device contextual data.

3. The one or more computer storage media of claim 2, wherein the content intent descriptor includes information for a plurality of items, and wherein the prompt is generated on the user device by selecting information for a first item from the plurality of items based on the on-device contextual data.

4. The one or more computer storage media of claim 1, wherein the prompt is generated on the user device by selecting the on-device contextual data based on the content intent descriptor.

5. The one or more computer storage media of claim 1, wherein the prompt is generated on the user device by combining the content intent descriptor with the on-device contextual data.

6. The one or more computer storage media of claim 1, wherein causing the generative model to generate a digital content item using the prompt comprises:
providing the prompt as input to the generative model on the user device.

7. The one or more computer storage media of claim 1, wherein causing the generative model to generate a digital content item using the prompt comprises:
communicating the prompt over the network to the content server, wherein the prompt is provided as input to the generative model on the content server; and wherein the digital content item is communicated over the network from the content server to the user device.

8. The one or more computer storage media of claim 1, wherein the on-device contextual data comprises one or more selected from the following: user demographics, user behavior data, and user device information.

9. The one or more computer storage media of claim 1, wherein the on-device contextual data is encrypted on the user device.

10. A computer-implemented method comprising:
receiving, at a user device, a content intent descriptor communicated over a network from a content server;
in response to receiving the content intent descriptor, generating, on the user device, a prompt using the content intent descriptor and on-device contextual data;
providing, by the user device, the prompt over the network to the content server, wherein the content server causes a generative model to generate a digital content item using the prompt;
receiving, at the user device, the digital content item communicated over the network from the content server; and
presenting, by the user device, the digital content item.

11. The computer-implemented method of claim 10, wherein the prompt is generated on the user device by selecting information from the content intent descriptor based on the on-device contextual data.

12. The computer-implemented method of claim 11, wherein the content intent descriptor includes information for a plurality of items, and wherein the prompt is generated on the user device by selecting information for a first item from the plurality of items based on the on-device contextual data.

13. The computer-implemented method of claim 10, wherein the prompt is generated on the user device by identifying the on-device contextual data based on the content intent descriptor.

14. The computer-implemented method of claim 10, wherein the prompt is generated on the user device by combining the content intent descriptor with the on-device contextual data.

15. The computer-implemented method of claim 10, wherein the on-device contextual data is encrypted on the user device.

16. A computer system comprising:
a generative model;
a content intent descriptors data store storing one or more content intent descriptors; and
one or more content servers coupled to the generative model and the content intent descriptors data store, the one or more content servers: (1) providing a selected content intent descriptor over a network to a user device; (2) receiving a prompt over the network from the user device that generated the prompt using the selected content intent descriptor and on-device contextual data; (3) providing the prompt to the generative model to cause the generative model to generate a digital content item using the prompt; and (4) providing the digital content item over the network to the user device for presentation by the user device.

17. The computer system of claim 16, wherein the prompt is generated on the user device by selecting information from the content intent descriptor based on the on-device contextual data.

18. The computer system of claim 17, wherein the content intent descriptor includes information for a plurality of items, and wherein the prompt is generated on the user device by selecting information for a first item from the plurality of items based on the on-device contextual data.

19. The computer system of claim 16, wherein the prompt is generated on the user device by identifying the on-device contextual data based on the content intent descriptor.

20. The computer system of claim 16, wherein the prompt is generated on the user device by combining the content intent descriptor with the on-device contextual data.
